(19) United States
(12) Patent Application Publication
(10) Pub. No.: US 2014/0003792 A1
(43) Pub. Date: Jan. 2, 2014

(54) SYSTEMS, METHODS, AND MEDIA FOR SYNCHRONIZING AND MERGING SUBTITLES AND MEDIA CONTENT

(71) Applicant: Kourosh Soroushian, San Diego, CA (US)

(72) Inventor: Kourosh Soroushian, San Diego, CA (US)

(21) Appl. No.: 13/537,459

(22) Filed: Jun. 29, 2012

(51) Int. Cl. H04N 5/92

(52) U.S. Cl. 386/244; 386/E05.009

(57) ABSTRACT

Systems, methods, and media for synchronizing and merging subtitles and media content are provided. In some embodiments, systems for synchronizing and merging subtitles and media content are provided, the systems comprising processing circuitry that is configured to: receive subtitles; receive media content; identify a synchronization point in the subtitles and a corresponding synchronization point in the media content; synchronize the subtitles and the media content based on the synchronization point and the corresponding synchronization point; and present the subtitles with the media content based on the synchronization.

### BACKGROUND OF THE INVENTION

With explosive growth in the availability of media content (such as movies, television programs, video clips, etc.) via both physical media (such as DVDs, CDs, etc.) and communication networks (such as cable networks, satellite networks, the Internet, etc.) to users in different places around the world, there is a growing need to provide translations of languages used in such media content along with a presentation of the media content.

One effective way in which such translations can be provided is through subtitles presented with the media content. Unfortunately, however, even if a piece of media content provides subtitles (which in many instances is not the case), the subtitles are typically only available in one or two languages, such as English and Spanish. Thus, these subtitles are ineffective to provide translations for people who speak other languages such as French, Italian, Russian, Mandarin, Japanese, Hindi, Urdu, Farsi, Arabic, etc.

One reason that subtitles may not be provided with media content is that producing subtitles in many different languages can be expensive for media content producers.

In response to this lack of availability of media-content-producer-provided subtitles, communities of media content consumers have formed in which subtitles are generated and shared within the community. An example of such a community is opensubtitles.org. On this community's Web site, subtitles for nearly 125,000 movies are currently available, and these subtitles are provided in over 50 different languages.

In an example of a subtitle file that can be obtained from such a community, the subtitles are provided in text form along with time codes that indicate when in the media content the corresponding text should be presented to a viewer. For example, a subtitle file may be of the form: “<Start Time> <End Time> <spoken words of an actor>”, where <Start Time> indicates when the “spoken words of an actor” start, <End Time> indicates when the “spoken words of an actor” end, and <spoken words of an actor> are the spoken words in the subtitle language.

One difficulty with such subtitle files is ensuring that their time codes in fact correspond to times codes of video being presented with media content. For example, if subtitles are presented too long before or too long after corresponding movements of an actor's lips, the viewing experience can be greatly diminished. An example of a reason why the time codes may not match is that the subtitles were created based on a different source of the media content (e.g., one with a longer opening or one with a faster playback or one with different edit points) than the source of the media content available to a viewer.

Accordingly, systems, methods, and media for synchronizing and merging subtitles and media content are provided.

### SUMMARY OF THE INVENTION

In view of the foregoing, systems, methods, and media for synchronizing and merging subtitles and media content are provided.

In particular, in some embodiments, systems for synchronizing and merging subtitles and media content are provided. In some embodiments, the systems comprise processing circuitry that is configured to: receive subtitles; receive media content; identify a synchronization point in the subtitles and a corresponding synchronization point in the media content; synchronize the subtitles and the media content based on the synchronization point and the corresponding synchronization point; and present the subtitles with the media content based on the synchronization. In some of these embodiments, the processing circuitry is also configured to determine a time period where synchronization between the media content and the subtitles is invalid and/or configured to perform translation on text of the subtitles.

In particular, in some embodiments, methods for synchronizing and merging subtitles and media content are provided. In some embodiments, the methods comprise: receiving subtitles; receiving media content; identifying a synchronization point in the subtitles and a corresponding synchronization point in the media content; synchronizing the subtitles and the media content based on the synchronization point and the corresponding synchronization point; and presenting the subtitles with the media content based on the synchronization. In some of these embodiments, the methods further comprise determining a time period where synchronization between the media content and the subtitles is invalid and/or comprise translating text of the subtitles.

In particular, in some embodiments, computer-readable media containing computer-executable instructions that, when executed by a processor, cause the processor to perform a method for synchronizing and merging subtitles and media content are provided. In some embodiments, the method comprises: receiving subtitles; receiving media content; identifying a synchronization point in the subtitles and a corresponding synchronization point in the media content; synchronizing the subtitles and the media content based on the synchronization point and the corresponding synchronization point; and presenting the subtitles with the media content based on the synchronization. In some of these embodiments, the method further comprises determining a time period where synchronization between the media content and the subtitles is invalid and/or, comprise translating text of the subtitles.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an example of a high-level flow diagram of a process for synchronizing and merging subtitles and media content in accordance with some embodiments of the invention;

FIGS. 2a and 2b show examples of flow diagrams of a process for determining one or more offsets and one or more rate differences between subtitles and media content in accordance with some embodiments of the invention;

FIG. 3 shows an example of a flow diagram of a process for synchronizing and merging subtitles and media content using one or more offsets and one or more rate differences in accordance with some embodiments of the invention;

FIG. 4 shows an example of a setup screen for a process for synchronizing and merging subtitles and media content in accordance with some embodiments of the invention;

FIG. 5 shows an example of an interactive media guidance application display that can be used with a process for synchronizing and merging subtitles and media content in accordance with some embodiments of the invention;

FIG. 6 shows an example of a block diagram of hardware that can be used with a process for synchronizing and merging subtitles and media content in accordance with some embodiments of the invention;

FIG. 7 shows an example of a block diagram of user equipment device hardware that can be used with a process for synchronizing and merging subtitles and media content in accordance with some embodiments of the invention;

FIG. 8 shows an example of a more detailed flow diagram of a process for synchronizing and merging subtitles and media content in accordance with some embodiments of the invention; and

FIG. 9 shows an example of an XML file for storing synchronization data in accordance with some embodiments of the invention.

### DETAILED DESCRIPTION OF EMBODIMENTS

This invention generally relates to systems, methods, and media for synchronizing and merging subtitles and media content.

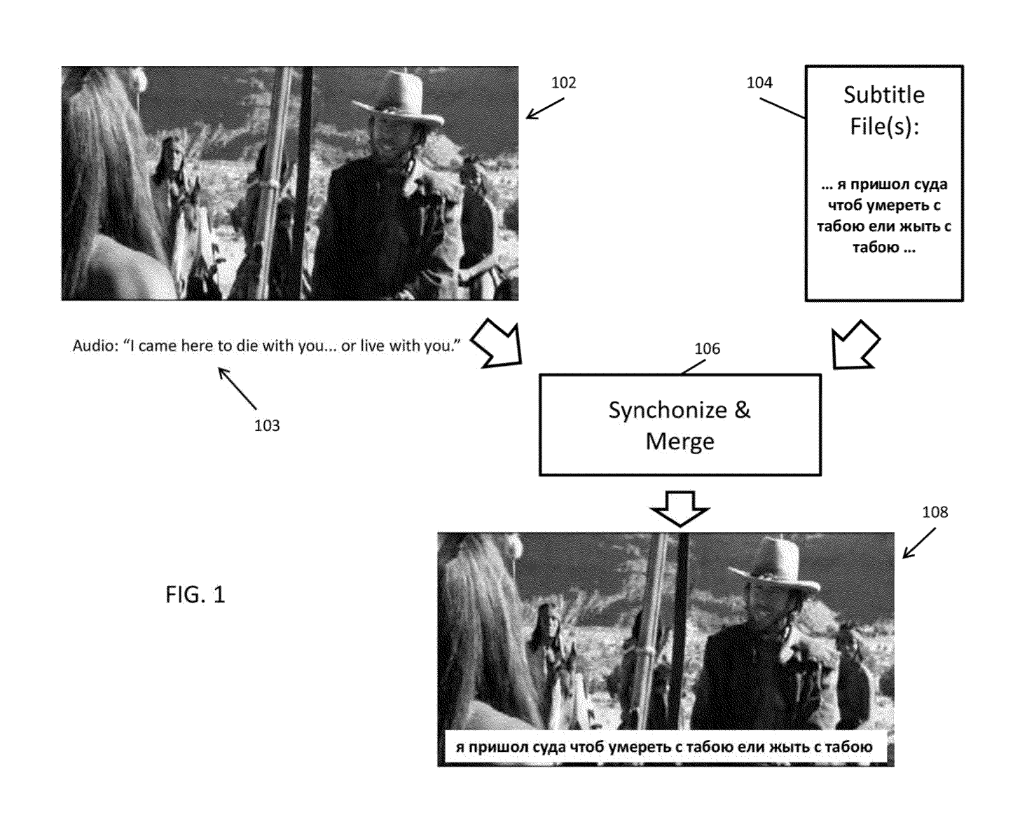

Turning to FIG. 1, as illustrated, media content 102 (which can include an audio portion 103), such as a movie, and subtitles from a subtitle file 104 can be synchronized and merged by a synchronization and merging mechanism 106 to provide media content with desired subtitles 108.

As referred to herein, the term “media content” should be understood to mean one or more electronically consumable media assets, such as television programs, pay-per-view programs, on-demand programs (e.g., as provided in video-on-demand (VOD) systems), Internet content (e.g., streaming content, downloadable content, Webcasts, etc.), movies, films, video clips, audio, audio books, and/or any other media or multimedia and/or combination of the same in which the presentation of subtitles can be beneficial or desired. As referred to herein, the term “multimedia” should be understood to mean media content that utilizes at least two different content forms described above, for example, text, audio, images, video, or interactivity content forms. Media content may be recorded, played, displayed or accessed by user equipment devices, but can also be part of a live performance. In some embodiment, media content can include over-the-top (OTT) content. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC.

Media content can be provided from any suitable source in some embodiments. For example, in some embodiments, media content can be provided from a readable media player such as a DVD player playing a DVD. In such case, for example, the media content can be a movie. In some embodiments, media content can be electronically delivered to a user's location from a remote location. For example, media content, such as a Video-On-Demand movie, can be delivered to a user's home from a cable system server. As another example, media content, such as a television program, can be delivered to a user's home from a streaming media provider over the Internet. In some embodiments, media content can be stored on and played from a media storage device of a user at the user's location. For example, media content, such as a recorded television show, can be stored on a digital video recorder (DVR) and played back upon demand by a user.

Any suitable subtitle content can be provided, in some embodiments. For example subtitles can be provided for any suitable media content, in any suitable language, and can be provided with (or without) any suitable time codes. Additional information can also be provided with subtitles, such as an identifier (such as name) of the media content, an identifier (such as name) of the author of the subtitles, an identifier (such as name) of the language of the subtitles, a date of creation of the subtitles, an identifier of the manner in which the subtitles were created (e.g., manually or automatically), and/or any other suitable information.

Subtitles can be provided in any suitable format in some embodiments. For example, subtitles can be provided in a text file, subtitles can be provided as a stream of content from a remote source, etc. More particularly, for example, subtitles (whether in a file or in a streaming format) can be received from a community Web site, can be received from a subscription-based service's server, etc.

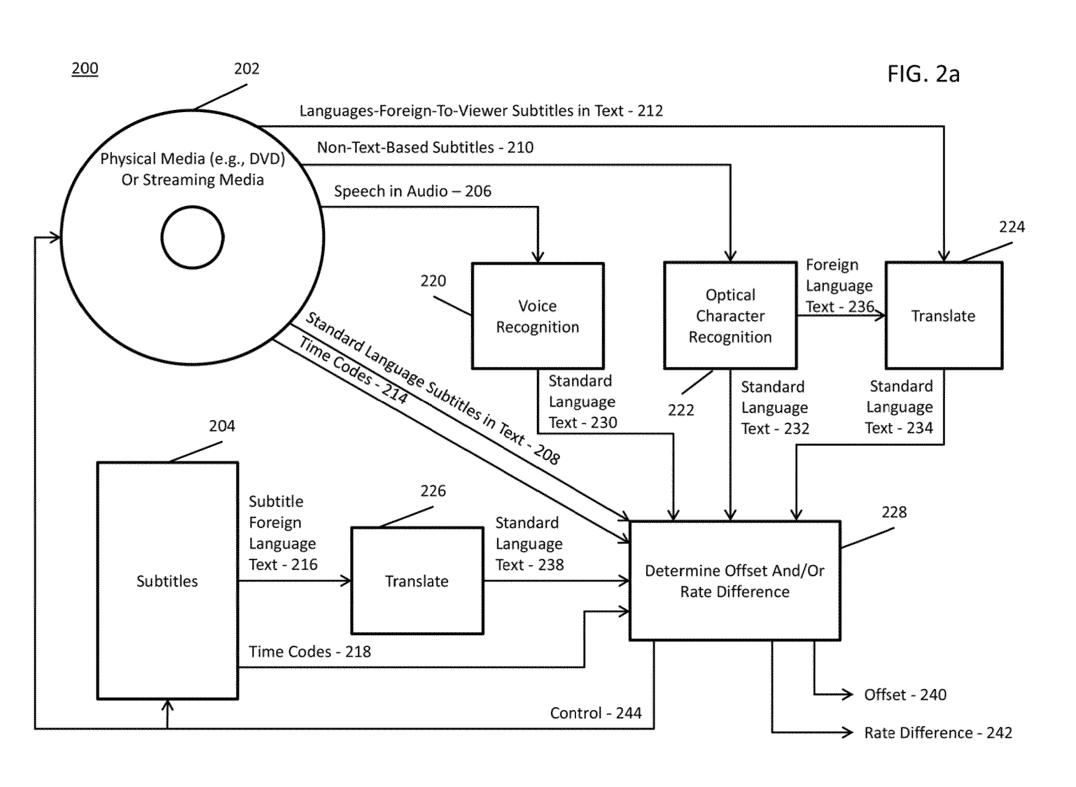

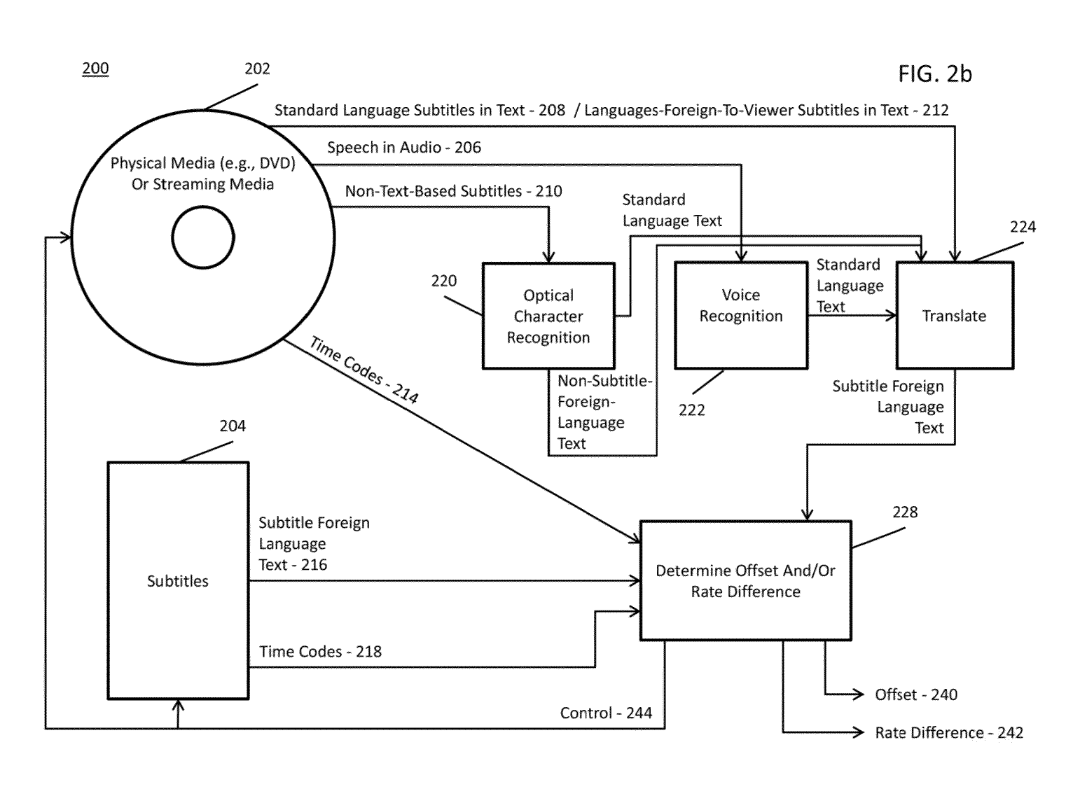

FIG. 2a shows an example 200 of a process for determining the synchronization needed between media content 202 and subtitles 204 in some embodiments. As illustrated, media content 202, which may be stored on a DVD or any other suitable source as described herein, may include speech in audio 206, standard language (e.g., English) subtitles in text 208, non-text-based subtitles 210, languages-foreign-to-viewer subtitles in text 212, and/or time codes 214.

Subtitles 204, which can be from a subtitle file or any other suitable source as described herein, may include subtitle foreign language (i.e., the language desired by a viewer) text 216 and/or time codes 218.

In order to determine the synchronization needed (if any) between the media content and the subtitles, the to-be-translated content (e.g., the words spoken by an actor) of the media content and the subtitles can be converted as necessary into a common language and then the two compared to determine any offsets (or offsets) and/or any playback rate difference (or rated differences). In the example illustrated in FIG. 2a, the translation is made to a “standard language,” which can be English, Spanish, any other suitable real language, or an artificial language other than the foreign language of the subtitles, in some embodiments. However, in some embodiments, the common language used to compare the to-be-translated content and the subtitles can be a foreign language of the subtitles as shown in FIG. 2b.

As shown in FIG. 2a, in some embodiments, speech in audio 206 can be provided to a voice recognition mechanism 220, which can then produce standard language text 230. Any suitable voice recognition mechanism can be used in some embodiments. For example, voice recognition mechanism 220 can include any suitable software and/or hardware, and can be provided at a viewer's location or can be provided as a service by a server on a communications network.

Languages-foreign-to-viewer subtitles in text 212 (i.e., non-standard language subtitles in text that are not in the same language as subtitles 204) can be provided to a translation mechanism 224, which can then produce standard language text 234. Any suitable translation mechanism can be used in some embodiments. For example translation mechanism 224 can include any suitable software and/or hardware, and can be provided at a viewer's location or can be provided as a service by a server on a communications network.

Non-text-based subtitles 210 can be provided to an optical character recognition (OCR) mechanism 222, which can then produce standard language text 232 and/or foreign language text 236 based on the language provided in the non-text-based subtitles. Foreign language text 236 can then be provided to translation mechanism 224, which, as described above, can produce standard language text 234. Any suitable OCR mechanism can be used in some embodiments. For example OCR mechanism 222 can include any suitable software and/or hardware, and can be provided at a viewer's location or can be provided as a service by a server on a communications network.

Subtitle foreign language text 216 (i.e., text in the desired subtitle language) can be provided to a translation mechanism 226, which can then produce standard language text 238. Any suitable translation mechanism can be used in some embodiments. For example translation mechanism 226 can include any suitable software and/or hardware, and can be provided at a viewer's location or can be provided as a service by a server on a communications network. In some embodiments, translation mechanism 226 can be the same as translation mechanism 224.

Standard language text 230, 232, and/or 234, time codes 214, standard language text 238, and time codes 218 can then be provided to a mechanism 228 for determining one or more offsets 240 and one or more rate differences 242 between the to-be-translated content and the subtitles.

The one or more offsets 240 and one or more rate differences 242 can be determined in any suitable manner. For example, in some embodiments, standard language text 230, 232, or 234 and standard language text 238 can be reviewed to identify one or more synchronization points in the two sets of text, and the time codes for those points compared (e.g., subtracted) to determine the offset(s) (e.g., time difference) between the two sets of text. Each synchronization point in the two sets of text can be an identical group of one or more post-translation words in each set, a group of one or more words having the same meaning in each set, one or more sequences of a given number of words in each set, etc., in some embodiments. In some embodiments, offsets can be determined at the beginning of media content, at the end of media content, and/or at any suitable one or more points in between.

As another example, in some embodiments, one or more rate differences between the two sets of text can be determined by comparing the time between two synchronization points in the to-be-translated set of text to the time between the corresponding synchronization points in the subtitle text. More particularly, for example, in some embodiments, this rate difference can be expressed as:

$$Δ R = \frac{{t}_{MC , y} - {t}_{MC , x}}{{t}_{S , y} - {t}_{S , x}} ,$$

where:
t_{MC,y} is the time code of a synchronization point y in the media content;
t_{MC,x} is the time code of an earlier synchronization point x in the media content;
t_{S,y} is the time code of a corresponding synchronization point y in the subtitles; and
t_{S,x} is the time code of a corresponding earlier synchronization point x in the subtitles.
   In some embodiments, point y can be at the end of the media content and point x can be at the beginning of the media content to maximize the accuracy of the rate distance calculation. In some embodiments, where the rate of playback of media content or subtitles is not constant, rate differences can be calculated for multiple periods in the media content and the subtitles.

The calculations of offsets and rate differences can be performed before or during presentation of media content in some embodiments.

For example, in some embodiments in which the offset and the rate differences are calculated during a presentation of media content, an offset is calculated at the beginning of the presentation and that offset used for a given period of time, after which the offset is recalculated and a rate difference is calculated. The new offset and the rate difference can then be used for a next given period of time, after which both the offset and the rate difference can be recalculated and used.

As another example, in some embodiments in which the offset and the rate differences are calculated before a presentation of media content, the media content and the subtitles can be reviewed at different points by controllably accessing the media content and the subtitles using a control signal 244. In this way, one or more offsets and one or more rate differences can be calculated across the entire media content before presenting the media content to a viewer.

In some embodiments, the source of the audio, video, and the accompanying subtitles may be from one or more streaming services, while the desired subtitle can be available in its entirety from an alternate source. In the case of live streaming, the determination of the initial offset can be performed as described above, in some embodiments. The overall synchronization process, however, can be performed in real-time, in some embodiments, so that the timing of the playback of the media content is unaffected by the subtitle synchronization and presentation. Once the initial offset has been determined, the calculation of the rate difference can commence over a specific period of time (for example one minute) and apply to the remaining subtitles. During any portion of the media content presentation during which the subtitles are determined to be out of synchronization, the presentation of subtitles may be optionally disabled in some embodiments.

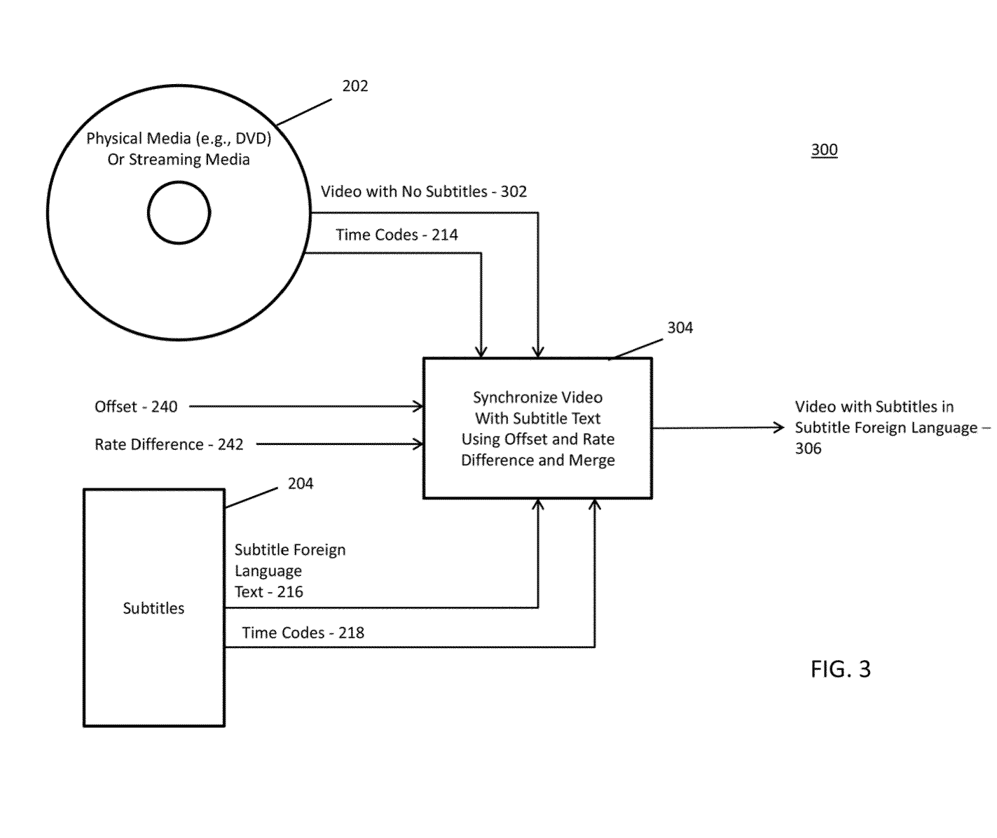

Turning to FIG. 3, an example 300 of a process for synchronizing and merging media content 202 and subtitles 204 using the determined one or more offsets 240 and/or the determined one or more rate differences 242 in accordance with some embodiments is shown. As illustrated, video with no subtitles 302, subtitle foreign language text 216, time codes 214, time codes 218, one or more offsets 240, and one or more rate differences 242 can be provided to a mechanism 304 for synchronizing and merging the video and subtitles to produce video with subtitles in the subtitle foreign language text 306.

Mechanism 304 can synchronize the video and the foreign language text in any suitable manner. For example, in some embodiments, mechanism 304 can synchronize the video and the foreign language text by subtracting an offset corresponding to the beginning of the media content from time codes 218 of the subtitles and using the modified time codes to align the foreign language text to time codes 214 of the video. Alternatively, for example, in some embodiments, mechanism 304 can synchronize the video and the foreign language text by adding an offset corresponding to the beginning of the media content to time codes 214 of the media content and using the modified time codes to align the foreign language text to time codes 218 of the subtitles. In this way, any offset at the beginning of the media content and subtitles can be removed.

As yet another example, in some embodiments, mechanism 304 can synchronize the video and the foreign language text by multiplying time codes 218 of the subtitles by a determined rate difference and using the modified time codes to align the foreign language text to time codes 214 of the video. Alternatively, for example, in some embodiments, mechanism 304 can synchronize the video and the foreign language text by dividing time codes 214 of the media content by a determined rate difference and using the modified time codes to align the video to time codes 218 of the subtitle foreign language text. In this way, any rate difference in the playback times of the media content and subtitles can be removed.

In some embodiments, mechanism 304 can determine synchronization for only the foreign language text that has not yet been presented in the video by using any of the synchronization methods described herein.

In some embodiments, mechanism 304 can determine whether synchronization has been lost and can provide a signal which can be used to optionally disable the display of subtitles until synchronization has been recovered. For example, such a signal can be presented as an on-screen “disable/re-enable subtitles” button that pops-up during an out-of-synchronization scenario in some embodiments.

In instances in which multiple offsets and/or multiple rate differences are determined, each offset and/or each rate difference can be used for a period in which it is applicable. For example, if three synchronization points are identified in a piece of media content with one at the beginning, one in the middle, and one at the end of the piece of media content, a first offset and a first rate difference may be used for the period between the synchronization point at the beginning and the synchronization point in the middle, and a second offset and a second rate difference may be used for the period between the synchronization point in the middle and the synchronization point at the end of the piece of media content.

The synchronized media content video and subtitle foreign language text can then be merged by mechanism 304 combining the media content video and video of the subtitle foreign language text into a video 306 with subtitles in subtitle foreign language. An example of this is shown as 108 in FIG. 1. Video 306 can then be provided to any suitable display for presentation to a viewer.

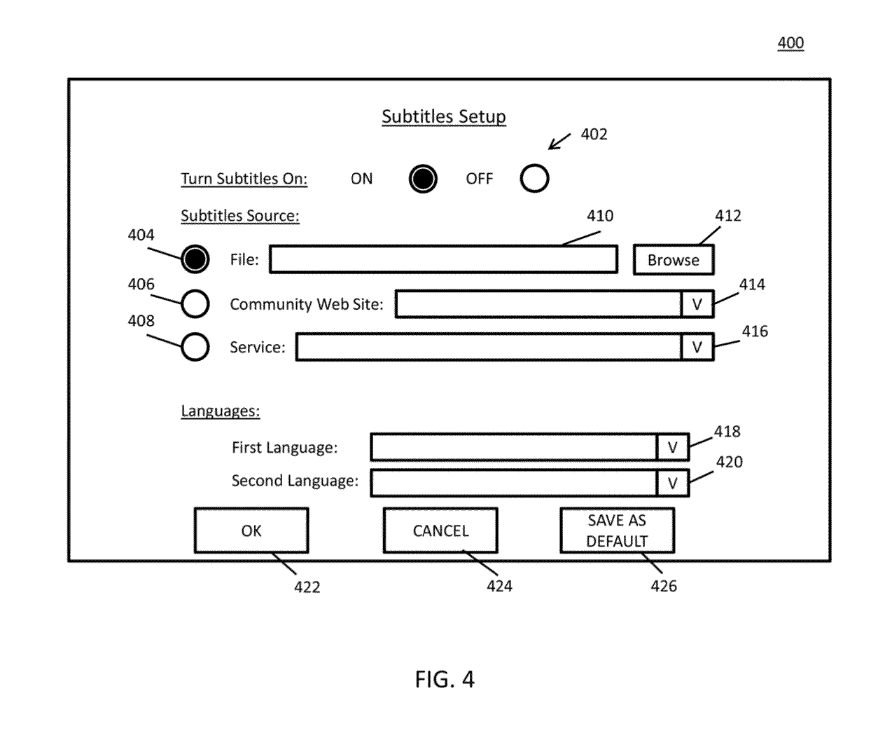

Turning to FIG. 4, an example 400 of a user interface that can be used to set-up subtitles for presentation with media content in some embodiments is illustrated. User interface 400 may be presented at any suitable point in some embodiments. For example, interface 400 can be presented in response to a user selecting a “Subtitles Setup” option from an on-screen menu of media content, such as a DVD, in some embodiments. As another example, interface 400 can be presented in response to a user pressing a “CC” button on a remote control while a piece of media content is being presented, or about to be presented.

As shown, in some embodiments, in response to being presented with interface 400, a user can select to turn on or off subtitles using radio buttons 402. Once the subtitles are on, the subtitles may then be presented during a presentation of media content, e.g., as described above in connections with FIGS. 1-3.

Using radio buttons 404, 406, and 408, a user can select whether subtitles are to be retrieved from a subtitle file, a subtitle community Web site, or a subtitle service, respectively, in some embodiments. If the subtitles are to be retrieved from a file, the name of the file can be received from the user in field 410 or by the user browsing to the desired file using browse button 412. If the subtitles are to be retrieved from a subtitle community Web site, the name of the subtitle community Web site can be received from a user selection from drop-down menu 414. If the subtitles are to be retrieved from a subtitle service, the name of the subtitle service can be received from a user selection from drop-down menu 416. Additionally or alternatively, the content may be identified using audio or video fingerprinting technology, using an electronic guide in the case of broadcast or streaming content, or through an analysis of the structural content of the physical media. When using an automated content identification process, the name of the content may be used to seed the search for the subtitle file automatically.

In some embodiments, a user can specify one or more languages of subtitles to be presented for media content. For example, in some embodiments, the user can specify using drop down menu 418 that subtitles should be presented in a first language if that language is available. As another example, in some embodiments, the user can specify using drop down menu 420 that subtitles should be presented in a second language if the that language is available and the first language is not available. Using source setting 414 or 416, language setting(s) 418 and/or 420, and the name of the media content (which can be retrieved from a selected piece of media content), subtitles can automatically be retrieved from a selected source, in some embodiments.

Using buttons 422, 424, and 426, a user can then selected to accept these settings, cancel the entry of these settings, and save these settings as default settings, respectively.

Media content to be synchronized and merged with subtitles, such as subtitles from a source selected as shown in FIG. 4, can be selected in any suitable manner in some embodiments. For example, in some embodiments, media content can be selected by a user selecting a DVD movie for presentation. As another example, media content can be selected by a user tuning to a channel on which the media content is being presented. As yet another example, media content can be selected by a user selecting the media content for presentation from an interactive media guidance application (which can also be referred to herein as a media guidance application or a guidance application).

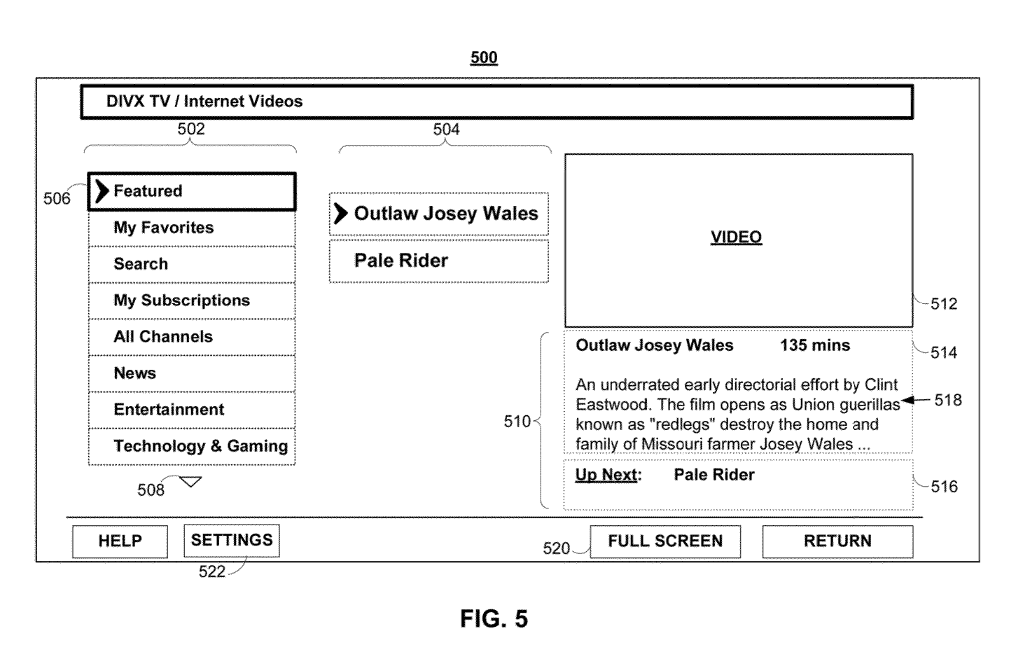

FIG. 5 shows an example 500 of a guidance display that can be provided as part of an interactive media guidance application in accordance with some embodiments. As illustrated, a user may be presented with display 500 in response to the user selecting a selectable option provided in a displayed menu (e.g., an “Internet Videos” option, a “DivXTV” option, a “Program Listings” option, etc.), pressing a dedicated button (e.g., a GUIDE button) on a user input interface or device, and/or taking any other suitable action.

As illustrated in FIG. 5, guidance display 500 may include lists of media identifiers, such as a first list of media identifiers 502 that lists categories of media content, and a second list of media identifiers 504 that lists particular pieces of media content within a selected category that are available for presentation.

Additional media guidance data, such as additional media identifiers, may be presented in response to a user selecting a navigational icon 508.

Display 500 may also include a media queue region 510 that lists one or more pieces of media content selected and queued for playback, and a video region 512 in which pieces of media content can be presented.

In some embodiments, information relating to a piece of media content can also be presented to a user. For example, information 518 can include a name of a piece of media content, a time at which the media content is available (if applicable), a source (e.g., channel, Web address, etc.) from which the media content can be obtained, a parental rating for the piece of media content, a duration of the piece of media content, a description of the piece of media content, a review or a quality rating of the piece of media content, and/or any other suitable information.

In some embodiments, pieces of media content can be played in a full sized display screen in response to a user selecting “full screen” button 520.

In some embodiments, a user may be able to set settings related to the interactive media guidance application and/or the synchronizing and merging of content and subtitles by pressing a settings button, such as settings button 520 of FIG. 5. The settings that can be set can include any suitable settings such as channel and program favorites, programming preferences that the guidance application can utilize to make programming recommendations, display preferences, language preferences, the settings described above in connection with FIG. 4, and/or any other suitable settings. For example, if the user sets a language as a preferred display language, that language can be used for information presented in an interactive media guidance application as well as in subtitles presented for displayed media content (e.g., by making the set language the language in menu 418 of FIG. 4).

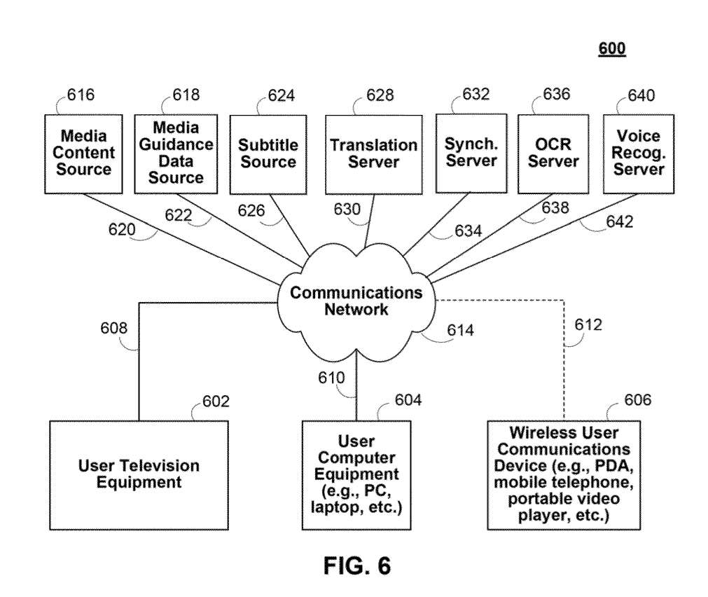

Turning to FIG. 6, an example 600 of an architecture of hardware that can be used in accordance with some embodiments is shown. As illustrated, architecture 600 can include a user television equipment device 602, a user computer equipment device 604, a wireless user communication device 606, a communications network 614, a media content source 616, a media guidance data source 618, a subtitle source 624, a translation server 628, a synchronization server 632, an optical character recognition server 636, a voice recognition server 640, and communication paths 608, 610, 612, 620, 622, 626, 630, 634, 638, and 642.

In some embodiments, user television equipment device 602, user computer equipment device 604, and wireless user communication device 606, which can each be referred to herein as a “user equipment device,” can be any suitable devices for presenting media content with subtitles, presenting an interactive media guidance application for selecting content, synchronizing content and subtitles, merging content and subtitles, and/or performing any other suitable functions as described herein.

User television equipment device 602 can be any suitable user television equipment device or devices in some embodiments. For example, in some embodiments, user television equipment device 602 can include any suitable television, smart TV, set-top box, integrated receiver decoder (IRD) for handling satellite television, digital storage device, digital media receiver (DMR), digital media adapter (DMA), streaming media device, DVD player, DVD recorder, connected DVD, local media server, BLU-RAY player, BLU-RAY recorder, any other suitable user television equipment, and/or any other suitable combination of the same.

User computer equipment 604 can be any suitable user computer equipment in some embodiments. For example, in some embodiments, user computer equipment 604 can include any suitable personal computer (PC), laptop computer, tablet computer, WebTV box, personal computer television (PC/TV), PC media server, PC media center, hand-held computer, stationary telephone, non-portable gaming machine, any other suitable user computer equipment, and/or any other suitable combination of the same.

Wireless user communication device 606 can be any suitable wireless user communication device or devices in some embodiments. For example, in some embodiments, Wireless user communication device 606 can include any suitable personal digital assistant (PDA), mobile telephone, portable video player, portable music player, portable gaming machine, smart phone, any other suitable wireless device, and/or any suitable combination of the same.

In some embodiments, user equipment devices may function as standalone devices or may be connectable to a communications network. For example, in some embodiments, user equipment devices may be Internet-enabled allowing them to access Internet media content, and/or may include a tuner allowing them to access content transmitted on a television distribution network (such as a cable network, satellite network, etc.).

In some embodiments, communications network 614 may be any one or more networks including the Internet, a mobile phone network, a mobile voice, a mobile data network (e.g., a 3G, 4G, or LTE network), a cable network, a satellite network, a public switched telephone network, a local area network, a wide area network, any other suitable type of communications network, and/or any suitable combination of communications networks.

Media content source 616 may include one or more types of content distribution equipment for distributing any suitable media content, including television distribution facility equipment, cable system head-end equipment, satellite distribution facility equipment, programming source equipment (e.g., equipment of television broadcasters, such as NBC, ABC, HBO, etc.), intermediate distribution facility equipment, Internet provider equipment, on-demand media server equipment, and/or any other suitable media content provider equipment. NBC is a trademark owned by the National Broadcasting Company, Inc., ABC is a trademark owned by the ABC, INC., and HBO is a trademark owned by the Home Box Office, Inc.

Media content source 616 may be operated by the originator of content (e.g., a television broadcaster, a Webcast provider, etc.) or may be operated by a party other than the originator of content (e.g., an on-demand content provider, an Internet provider of content of broadcast programs for downloading, etc.).

Media content source 616 may be operated by cable providers, satellite providers, on-demand providers, Internet providers, providers of over-the-top content, and/or any other suitable provider(s) of content.

Media content source 616 may include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 618 may provide any suitable media guidance data, such as names of pieces of media content, times at which the media content is available (if applicable), sources (e.g., channels, Web addresses, etc.) from which the media content can be obtained, parental ratings for the pieces of media content, durations of the pieces of media content, descriptions of the pieces of media content, reviews or quality ratings of the pieces of media content, and/or any other suitable information.

Media guidance data may be provided by media guidance data source 618 to the user equipment devices using any suitable approach. In some embodiments, for example, an interactive media guidance application may be a stand-alone interactive television program guide that receives this media guidance data from media guidance data source 618 via a data feed (e.g., a continuous feed or trickle feed). In some embodiments, this media guidance data may be provided to the user equipment on a television channel sideband, using an in-band digital signal, using an out-of-band digital signal, or by any other suitable data transmission technique from media guidance data source 618. In some embodiments, this media guidance data may be provided to user equipment on multiple analog or digital television channels from media guidance data source 618. In some embodiments, media guidance data from media guidance data source 618 may be provided to users' equipment using a client-server approach, wherein media guidance data source 618 acts as a server.

Subtitle source 624 can be any suitable source of any suitable subtitle data, such as, for example, subtitle text, subtitle time codes, an identifier (such as name) of the media content, an identifier (such as name) of the author of the subtitles, an identifier (such as name) of the language of the subtitles, a date of creation of the subtitles, an identifier of the manner in which the subtitles were created (e.g., manually or automatically), and/or any other suitable information, in some embodiments. Subtitle source can be file server, a community Web site, a service that streams subtitle data, etc., in some embodiments.

Translation server 628 can be any suitable server for performing translations in some embodiments. For example, server 628 can be a server that translates text from any suitable language into any other suitable language. In some embodiments, server 628 can perform one or both of the translation functions illustrated in translate blocks 224 and 226 of FIGS. 2a and 2b.

Synchronization server 632 can be any suitable server for identifying synchronization points, determining offsets and/or rate differences, and/or synchronizing subtitles and media content. For example, server 632 can identify synchronization points, determine offsets and/or rate differences, and/or synchronize subtitles and media content as described above in connection with FIGS. 2a, 2b, and 3.

Optical character recognition server 636 can be any suitable server for performing optical character recognition on media content video to provide text. For example, server 636 can be used to produce subtitle text from video with integrated subtitles. In some embodiments, server 636 can perform the optical character recognition function illustrated in optical character recognition block 222 of FIGS. 2a and 2b.

Voice recognition server 640 can be any suitable server for performing voice recognition on media content audio to provide text. For example server 640 can be used to produce text from audio being spoken in the media content. In some embodiments, server 640 can perform the voice recognition functions illustrated in voice recognition block 220 of FIGS. 2a and 2b.

Although only one each of user equipment devices 602, 604, and 606, sources 616, 618, and 624, and servers 628, 632, 636, and 640 are illustrated in FIG. 6 in order to avoid over complicating the drawing, any suitable number of each of these components can be provided in some embodiments. Each user may utilize more than one type of user equipment device in some embodiments. In some embodiments, any of user equipment devices 602, 604, and 606 can be combined, and any of sources 616, 618, and 624 and servers 628, 632, 636, and 640 can be combined.

Paths 608, 610, 612, 620, 622, 626, 630, 634, 638, and 642 may separately or together include one or more communications paths, such as, a satellite path; a fiber-optic path, a cable path, a path that supports Internet communications (e.g., IPTV), free-space connections (e.g., for broadcast or other wireless signals), or any other suitable wired or wireless communications path or combination of such paths. Path 612 is drawn with dotted lines to indicate that, in the exemplary embodiment shown in FIG. 6, it can be a wireless path (although this path may be a wired path, if desired), and paths 608, 610, 620, 622, 626, 630, 634, 638, and 642 are drawn as solid lines to indicate they can be wired paths (although these paths may be wireless paths, if desired). Communication to/from user equipment devices 602, 604, and 606, sources 616, 618, and 624, and servers 628, 632, 636, and 640 may be provided by one or more of communications paths 608, 610, 612, 620, 622, 626, 630, 634, 638, and 642, respectively, but are shown as a single path in FIG. 6 to avoid overcomplicating the drawing.

Although communications paths are not drawn between user equipment devices 602, 604, and 606, sources 616, 618, and 624, and servers 628, 632, 636, and 640, these components may communicate directly with each other via communication paths, such as those described above, as well via point-to-point communication paths, such as USB cables, IEEE 1394 cables, wireless paths (e.g., Bluetooth, infrared, IEEE 802.11x, etc.), or other communication via wired or wireless paths. BLUETOOTH is a certification mark owned by Bluetooth SIG, INC. The user equipment devices 602, 604, and 606, sources 616, 618, and 624, and servers 628, 632, 636, and 640 may also communicate with each other directly through an indirect path via communications network 614.

In some embodiments, sources 616, 618, and 624 and servers 628, 632, 636, and 640 can be implemented in any suitable hardware. For example, sources 616, 618, and 624 and servers 628, 632, 636, and 640 can be implemented in any of a general purpose device such as a computer or a special purpose device such as a client, a server, mobile terminal (e.g., mobile phone), etc. Any of these general or special purpose devices can include any suitable components such as a hardware processor (which can be a microprocessor, digital signal processor, a controller, etc.), memory, communication interfaces, display controllers, input devices, etc.

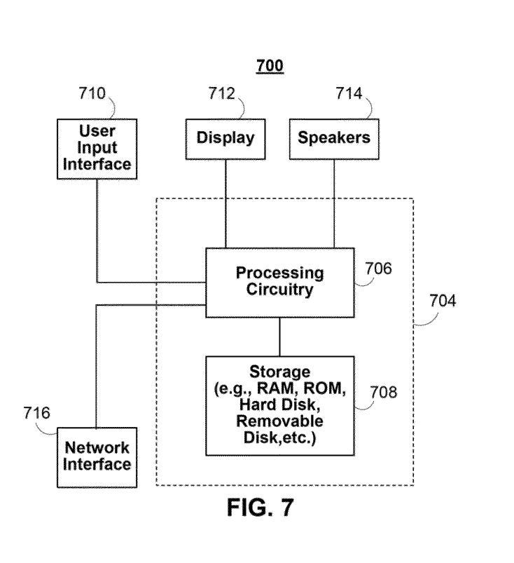

FIG. 7 shows an example of hardware that can be provided in an illustrative user equipment device 700, such as user television equipment device 602, user computer equipment device 604, and/or wireless user communication device 606 of FIG. 6, in accordance with some embodiments. As illustrated, device 700 can include control circuitry 704 (which can include processing circuitry 706 and storage 708), a user input interface 710, a display 712, speakers 714, and an input/output (hereinafter “I/O”) interface 716.

Control circuitry 704 may include any suitable processing circuitry such as processing circuitry 706. As referred to herein, processing circuitry 706 can be circuitry that includes one or more microprocessors, microcontrollers, digital signal processors, programmable logic devices, field-programmable gate arrays (FPGAs), application-specific integrated circuits (ASICs), hardware processors, etc., and may include a multi-core processor (e.g., dual-core, quad-core, hexa-core, or any suitable number of cores) or a supercomputer, in some embodiments. In some embodiments, processing circuitry may be distributed across multiple separate processors or processing units, such as, for example, multiple of the same type of processing units (e.g., two Intel Core i7 processors) or multiple different processors (e.g., an Intel Core i5 processor and an Intel Core i7 processor).

Storage 708 can be any suitable digital storage mechanism in some embodiments. For example, storage 708 can include any device for storing electronic data, program instructions, computer software, firmware, register values, etc., such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store media content, subtitle data, media guidance data, executable instructions (e.g., programs, software, scripts, etc.) for synching and merging, for providing an interactive media guidance application, and for any other suitable functions, and/or any other suitable data or program code, in accordance with some embodiments. Nonvolatile memory may also be used (e.g., to launch a boot-up routine and other instructions). Cloud-based storage may be used to supplement storage 708 or instead of storage 708 in some embodiments.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of the user equipment 700. Circuitry 704 may also include digital-to-analog converter circuitry and analog-to-digital converter circuitry for converting between digital and analog signals. The video generating circuitry may be used for rendering non-text-based subtitles and/or combining media content video and subtitle video. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or special purpose hardware processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

A user may send instructions to control circuitry 704 using user input interface 710. User input interface 710 may be any suitable user interface, such as a remote control, mouse, trackball, keypad, keyboard, touch screen, touchpad, stylus input, joystick, voice recognition interface, or other user input interfaces.

Display 712 may be provided as a stand-alone device or integrated with other elements of user equipment device 700. Display 712 may be one or more of a monitor, a television, a liquid crystal display (LCD) for a mobile device, or any other suitable equipment for displaying visual images. In some embodiments, display 712 may be HDTV-capable. In some embodiments, display 712 may be a 3D display.

A video card or graphics card may generate the output to display 712. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 704. The video card may be integrated with the control circuitry 704 or may be integrated with display 712.

Speakers 714 may be provided as integrated with other elements of user equipment device 700 or may be stand-alone units. The audio component of media content displayed on display 712 may be played through speakers 714. In some embodiments, the audio may be distributed to a receiver (not shown), which processes and outputs the audio via speakers 714.

I/O interface 716 can be any suitable I/O interface 716 in some embodiments. For example, in some embodiments, I/O interface 716 can be any suitable interface for coupling control circuitry 704 (and specifically processing circuitry 706) to one or more communications paths (e.g., paths 608, 610, and 612 described in FIG. 6). More particularly, for example, I/O interface 716 can include a cable modem, an integrated services digital network (ISDN) modem, a digital subscriber line (DSL) modem, a telephone modem, an Ethernet card, a fiber-optic modem, a wireless modem, and/or any other suitable communications circuitry. In some embodiments, the I/O interface can be used to provide content and data from an external location to device 700. For example, in some embodiments, I/O interface 716 can be used to provide media content (e.g., broadcast programming, on-demand programming, Internet content, content available over a local area network (LAN) or wide area network (WAN), and/or any other suitable content), media guidance data, subtitles, time codes, and/or any other suitable information or data to control circuitry 704 of device 700. In some embodiments, I/O interface 716 can also be used to send and receive commands, requests, and other suitable data from and to, respectively, control circuitry 704. Any suitable number of I/O interfaces 716 can be provided, even though only one is shown in FIG. 7 to avoid overcomplicating the drawing.

The processes for synchronizing and merging of media content and subtitles, the interactive media guidance application, and/or any other suitable functions as described herein may be implemented as stand-alone applications on user equipment devices in some embodiments. For example, the processes for synchronizing and merging of media content and subtitles and/or the interactive media guidance application may be implemented as software or a set of executable instructions which may be stored in storage 708, and executed by control circuitry 704 of a user equipment device 700.

In some embodiments, the processes for synchronizing and merging of media content and subtitles, the interactive media guidance application, and/or any other suitable functions as described herein may be implemented as client-server applications. In such client-server applications, a client application may reside on a user equipment device, and a server application may reside on a remote server, such as servers 618, 628, 632, 636, and/or 640. For example, the processes for synchronizing and merging may be implemented partially as a client application on control circuitry 704 of user equipment device 700 and partially as a server application on translation server 628 (which can perform translations for control circuitry 704), on synchronization server 632 (which can determined offsets and rate differences and synchronize the subtitles to the media content for control circuitry 704), on optical character recognition server 636 (which can perform optical character recognition for control circuitry 704), and/or on voice recognition server 640 (which can perform voice recognition for control circuitry 704). As another example, an interactive media guidance application may be implemented partially as a client application on control circuitry 704 of user equipment device 700 and partially on a remote server (e.g., media guidance data source 618 of FIG. 6) as a server application running on control circuitry of the remote server.

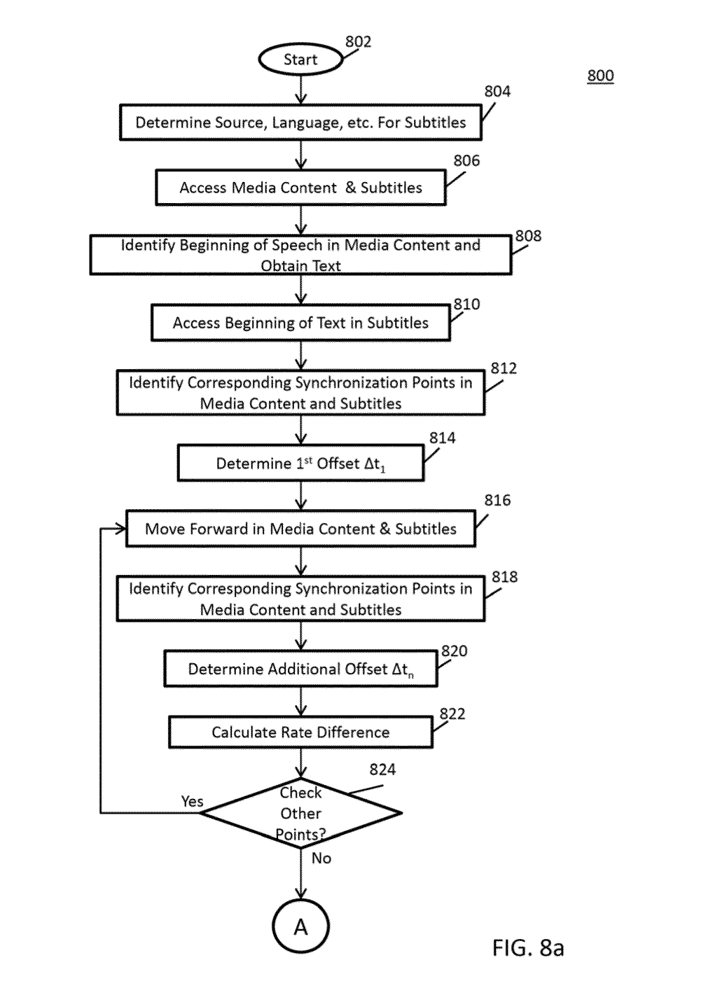

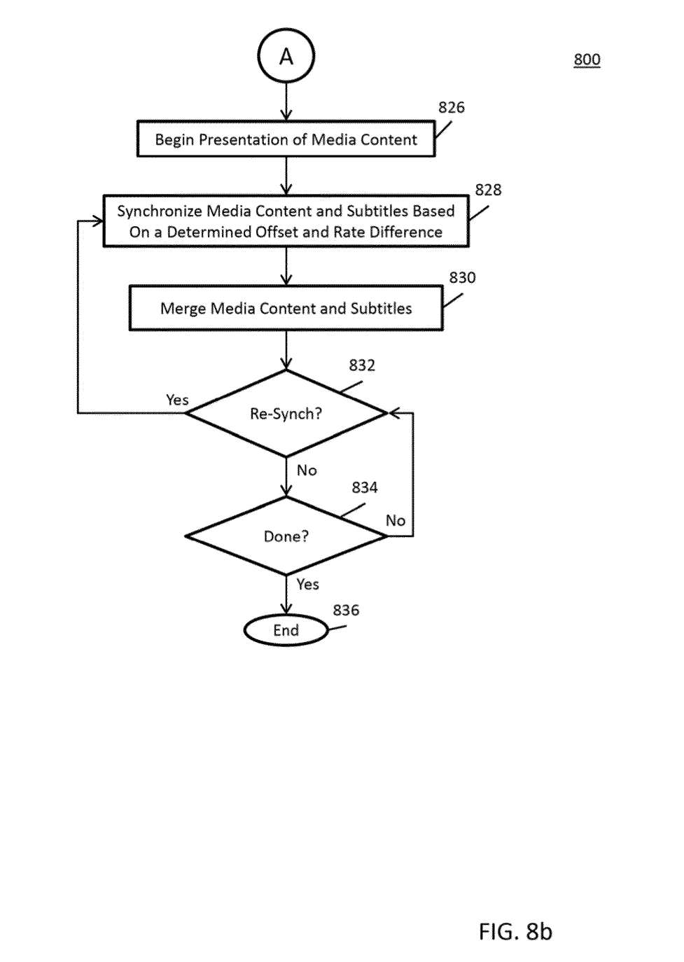

FIGS. 8a and 8b illustrate a flow diagram 800 for synchronizing and merging subtitles and media content in accordance with some embodiments of the invention. At least part of a process that performs what is described in FIGS. 8a and 8b, and herein in connection with those figures, can be stored as executable instructions in storage 708 and executed at least in part in control circuitry 704 of a user equipment device 700.

As shown in FIG. 8a, after process 800 begins at 802, control circuitry 704 can determine a source, a language, and any other suitable information for subtitles to be presented in connection with media content in some embodiments. This determination can be made in any suitable manner. For example, in some embodiments, control circuitry 704 can access settings accepted for the media content or saved as a default using a user interface 400 as described in connection with FIG. 4.

Next, at 806, control circuitry 704 can access media content and subtitles to be synchronized and merged. The media content and subtitles can be accessed in any suitable manner. For example, if the media content is on a DVD, the DVD can be read by the control circuitry to access the media content. As another example, if the media content is on a remote server, commands can be sent to the remote server by the control circuitry asking it to provide the media content. As yet another example, if the subtitles are on a file, the file can be opened by the control circuitry. As still another example, if the subtitles are on a remote server, commands can be sent to the remote server by the control circuitry asking it to provide the subtitles.

The beginning of speech in the media content can then be identified, and text obtained, by control circuitry 704 at 808 in some embodiments. The beginning of speech can be identified and text obtained in any suitable manner, such as those described above in connection with FIG. 2a. For example, the beginning of speech can be identified by control circuitry 704 using a voice recognition mechanism (such as software and/or hardware on the control circuitry or server 640) on audio of the media content to identify speech in the audio and obtain text corresponding to that speech, in some embodiments. As another example, in some embodiments, the beginning of speech can be identified and obtained from standard language subtitle text output from a media content source (such as a DVD). As yet another example, the beginning of speech can be identified by control circuitry 704 using an optical character recognition mechanism (such as software and/or hardware in the control circuitry or in server 636) on video of the media content to identify speech subtitles and obtain text corresponding to that speech, in some embodiments. In some embodiments, identifying speech and obtaining text for that speech can include translating the speech from one language to another by the control circuitry or by server 628.

Then, at 810, control circuitry 704 can access the beginning of the text in the subtitles. This text can be accessed in any suitable manner. For example, if the subtitles are stored in a file, the beginning of the text can be accessed by control circuitry 704 reading a first portion of the subtitle file, in some embodiments. As another example, if the subtitles are stored remotely, a request to receive a first portion of the subtitles can be sent, and a response with that portion can be received, by control circuitry 704, in some embodiments. In some embodiments, accessing text in the subtitles can include translating the text from one language to another by the control circuitry or by server 628.

Corresponding synchronization points in the media content and the subtitles can then be identified by the control circuitry at 812 in some embodiments. The synchronization points can be identified in any suitable manner. For example, in some embodiments, these synchronization points can be identified as described above in connection with FIG. 2a. More particularly, for example, synchronization points can be identified by the control circuitry as an identical group of one or more post-translation words in each of the media content and the subtitles, a group of one or more words having the same meaning in each of the media content and the subtitles, one or more sequences of a given number of words in each of the media content and the subtitles, etc., in some embodiments.

Next, at 814, a first offset between the media content and the subtitles can be determined by control circuitry 704 in some embodiments. The first offset can be determined in any suitable manner. For example, in some embodiments, the first offset can be determined as described above in connection with FIG. 2a. More particularly, for example, the first offset can be determined by the control circuitry as the difference in time between time codes corresponding to the synchronization points of the media content and the subtitles in some embodiments.

At 816, the control circuitry can move forward in the media content and the subtitles to identify additional synchronization points. The control circuitry can move forward by any suitable amount. For example, in some embodiments, the control circuitry can move to the end, or nearly the end, of the media content and the subtitles. As another example, in some embodiments, the control circuitry can move to a point between the beginning and the end of the media content and the subtitles. Control circuitry 704 can move forward by sending control signals to the source of the media content and the source of the subtitles.

Additional corresponding synchronization points in the media content and the subtitles can then be identified by the control circuitry at 818 in some embodiments. The synchronization points can be identified in any suitable manner. For example, in some embodiments, these synchronization points can be identified as described above in connection with FIG. 2a and as described above in connection with 812.

Then, at 820, an additional offset between the media content and the subtitles can be determined by control circuitry 704 in some embodiments. The additional offset can be determined in any suitable manner. For example, in some embodiments, the additional offset can be determined as described above in connection with FIG. 2a and as described above in connection with 814.

At 822, a rate difference between the media content and the subtitles can be determined by control circuitry 704. The rate difference can be determined in any suitable manner. For example, in some embodiments, the rate difference can be determined as described above in connection with FIG. 2a. More particularly, for example, in some embodiments, the rate difference can be calculated by the control circuitry using the following equation:

$$Δ R = \frac{{t}_{MC , y} - {t}_{MC , x}}{{t}_{S , y} - {t}_{S , x}} ,$$

where:
t_{MC,y} is the time code of a synchronization point y (e.g., a point determined at 818) in the media content;
t_{MC,x} is the time code of an earlier synchronization point x (e.g., a point determined at 812) in the media content;
t_{S,y} is the time code of a corresponding synchronization point y (e.g., a point determined at 818) in the subtitles; and
t_{S,x} is the time code of a corresponding earlier synchronization point x (e.g., a point determined at 812) in the subtitles.

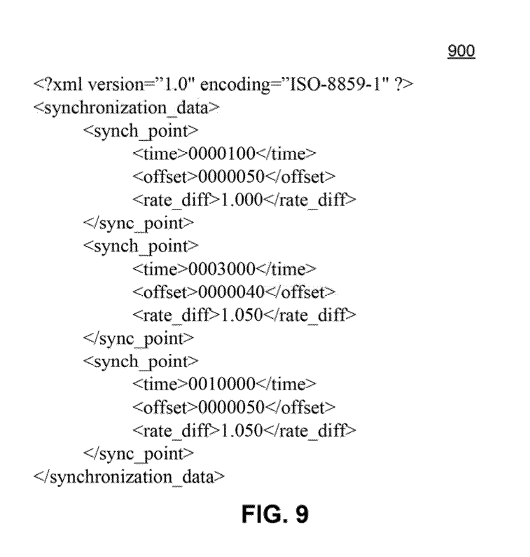

In some embodiments, synchronization point data, such as offsets and rate differences, can be stored for future playback of the pair of media content and subtitles, in some embodiments. This synchronization point data can be stored in any suitable manner. For example, as illustrated in FIG. 9, this data can be stored in an XML file in some embodiments.

Control circuitry 704 can next determine whether to check other points at 804. The control circuitry can make this determination based on any suitable criteria or criterion. For example, this determination can be based on a setting specifying a minimum number of points to be checked, based on a quality level associated with the source of the subtitles, and/or based on any other suitable factor(s). If it is determined that the control circuitry is to check other points, then process 800 can loop back to 816. Otherwise, the process can continue to 826 as shown in FIG. 8b.

As illustrated, at 826, control circuitry 704 can next begin presentation of the media content.

At 828, the media content and the subtitles can then be synchronized based on the first determined offset and the first determined rate difference by control circuitry 704, in some embodiments. This synchronization can be performed in any suitable manner. For example, in some embodiments, this synchronization can be performed by the control circuitry as described in FIG. 3. More particularly, for example, in some embodiments, this synchronization can be performed by the control circuitry subtracting an offset corresponding to the beginning of the media content from time codes of the subtitles and using the modified time codes to align the foreign language text to time codes of the video, and/or by multiplying time codes of the subtitles by a determined rate difference and using the modified time codes to align the foreign language text to time codes of the video.

The media content and the subtitles can next be merged at 830 by the control circuitry. This merging of the media content and subtitles can be performed in any suitable manner. For example, in some embodiments, video generated for the subtitles can be overlaid on the corresponding portion of the video from the media content (based on the synchronization) and a combined video signal output to a display 712, as illustrated, for example, in media content with desired subtitles 108 of FIG. 1.

Control circuitry can next determine whether to re-synchronize the media content and the subtitles at 832 in some embodiments. This determination can be made based on any suitable criteria or criterion. For example, this determination can be made based upon whether the offset and/or the rate difference changes at subsequent synchronization points. If the control circuitry determines that re-synchronization is to be performed, then process 800 can loop back to 828. Otherwise, the control circuitry can determine at 834 whether the process is done. The determination at 834 can be made in any suitable manner. For example, the control circuitry can determine that process 800 is done when all of the media content and subtitles have been synchronized and merged. If it is determined that process 800 is not done, then the process can loop back to 832. Otherwise, the process can terminate at 836.

It should be understood that the above steps of the flow diagram of FIGS. 8a and 8b may be executed or performed in any order or sequence not limited to the order and sequence shown and described in the figure. Also, some of the above steps of the flow diagram of FIGS. 8a and 8b may be executed or performed substantially simultaneously where appropriate or in parallel to reduce latency and processing times.

In some embodiments, any suitable computer readable media can be used for storing instructions for performing the mechanisms and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A system for synchronizing and merging subtitles and media content, the system comprising:
processing circuitry configured to:
receive subtitles;
receive media content;
identify a synchronization point in the subtitles and a corresponding synchronization point in the media content;
synchronize the subtitles and the media content based on the synchronization point and the corresponding synchronization point; and
present the subtitles with the media content based on the synchronization.

2. The system of claim 1, wherein the processing circuitry is configured to identify the synchronization point and the corresponding synchronization point by comparing text produced by voice recognition of audio of the media content to text produced by translation of the subtitles.

3. The system of claim 1, wherein the processing circuitry is configured to identify the synchronization point and the corresponding synchronization point by comparing text produced by voice recognition and translation of audio of the media content to text from the subtitles.

4. The system of claim 1, wherein the processing circuitry is configured to identify the synchronization point and the corresponding synchronization point by comparing text produced by optical character recognition of video of the media content to text produced by translation of the subtitles.

5. The system of claim 1, wherein the processing circuitry is configured to identify the synchronization point and the corresponding synchronization point by comparing text produced by optical character recognition and translation of the video of the media content to text from the subtitles.

6. The system of claim 1, wherein the processing circuitry is configured to identify the synchronization point and the corresponding synchronization point by comparing text produced by optical character recognition and translation of video of the media content to text produced by translation of the subtitles.

7. The system of claim 1, wherein the processing circuitry is configured to identify the synchronization point and the corresponding synchronization point by comparing subtitle text of the media content to text produced by translation of the subtitles.

8. The system of claim 1, wherein the processing circuitry is configured to identify the synchronization point and the corresponding synchronization point by comparing text produced by translation of subtitle text of the media content to text produced by translation of the subtitles.

9. The system of claim 1, wherein the processing circuitry is configured to identify the synchronization point and the corresponding synchronization point by comparing text corresponding to the media content to text corresponding to the subtitles, wherein each text is in a language spoken in the media content.

10. The system of claim 1, wherein the processing circuitry is configured to identify the synchronization point and the corresponding synchronization point by comparing text corresponding to the media content to text corresponding to the subtitles, wherein each text is in a language of the subtitles.

11. The system of claim 1, wherein the processing circuitry is configured to identify the synchronization point and the corresponding synchronization point by comparing text corresponding to the media content to text corresponding to the subtitles, wherein each text is in a language other than a language spoken in the media content and a language of the subtitles.

12. The system of claim 1, wherein the processing circuitry is also configured to determine an offset between the synchronization point and the corresponding synchronization point.

13. The system of claim 12, wherein the processing circuitry is configured to synchronize based on the offset.

14. The system of claim 1, wherein the processing circuitry is also configured to determine a rate difference between the media content and the subtitles using the synchronization point and the corresponding synchronization point.

15. The system of claim 14, wherein the processing circuitry is configured to synchronize based on the rate difference.

16. A method for synchronizing and merging subtitles and media content, the method comprising:
receiving subtitles;
receiving media content;
identifying a synchronization point in the subtitles and a corresponding synchronization point in the media content;
synchronizing the subtitles and the media content based on the synchronization point and the corresponding synchronization point; and
presenting the subtitles with the media content based on the synchronization.

17. The method of claim 16, wherein the identifying of the synchronization point and the corresponding synchronization point comprises comparing text produced by voice recognition of audio of the media content to text produced by translation of the subtitles.

18. The method of claim 16, wherein the identifying of the synchronization point and the corresponding synchronization point comprises comparing text produced by voice recognition and translation of audio of the media content to text from the subtitles.

19. The method of claim 16, wherein the identifying of the synchronization point and the corresponding synchronization point comprises comparing text produced by optical character recognition of video of the media content to text produced by translation of the subtitles.

20. The method of claim 16, wherein the identifying of the synchronization point and the corresponding synchronization point comprises comparing text produced by optical character recognition and translation of the video of the media content to text from the subtitles.

21. The method of claim 16, wherein the identifying of the synchronization point and the corresponding synchronization point comprises comparing text produced by optical character recognition and translation of video of the media content to text produced by translation of the subtitles.

22. The method of claim 16, wherein the identifying of the synchronization point and the corresponding synchronization point comprises comparing subtitle text of the media content to text produced by translation of the subtitles.

23. The method of claim 16, wherein the identifying of the synchronization point and the corresponding synchronization point comprises comparing text produced by translation of subtitle text of the media content to text produced by translation of the subtitles.

24. The method of claim 16, wherein the identifying of the synchronization point and the corresponding synchronization point comprises comparing text corresponding to the media content to text corresponding to the subtitles, wherein each text is in a language spoken in the media content.

25. The method of claim 16, wherein the identifying of the synchronization point and the corresponding synchronization point comprises comparing text corresponding to the media content to text corresponding to the subtitles, wherein each text is in a language of the subtitles.

26. The method of claim 16, wherein the identifying of the synchronization point and the corresponding synchronization point comprises comparing text corresponding to the media content to text corresponding to the subtitles, wherein each text is in a language other than a language spoken in the media content and a language of the subtitles.

27. The method of claim 16, further comprising determining an offset between the synchronization point and the corresponding synchronization point.

28. The method of claim 27, wherein the synchronizing is based on the offset.

29. The method of claim 16, further comprising determining a rate difference between the media content and the subtitles using the synchronization point and the corresponding synchronization point.

30. The system of claim 29, wherein the processing circuitry is configured to synchronize based on the rate difference.

31. A computer-readable medium containing computer-executable instructions that, when executed by a processor, cause the processor to perform a method for synchronizing and merging subtitles and media content, the method comprising:
receiving subtitles;
receiving media content;
identifying a synchronization point in the subtitles and a corresponding synchronization point in the media content;
synchronizing the subtitles and the media content based on the synchronization point and the corresponding synchronization point; and
presenting the subtitles with the media content based on the synchronization.
